(19) United States
(12) Patent Application Publication
(10) Pub. No.: US 2026/0203836 A1
(43) Pub. Date: Jul. 16, 2026

(54) ADAPTIVE WELL TIE-IN SYSTEM

(71) Applicant: Saudi Arabian Oil Company, Dhahran (SA)

(72) Inventors: Assem A. Alyomny, Al Khubar (SA); Behzad Khan, Dhahran (SA); Razen Alharbi, Dammam (SA)

(21) Appl. No.: 19/018,199

(22) Filed: Jan. 13, 2025

(51) Int. Cl. G06Q 50/02; E21B 41/00; G06Q 10/0631

(52) U.S. Cl. CPC G06Q 50/02; E21B 41/00; G06Q 10/06315

(57) ABSTRACT

Disclosed are methods, systems, and computer-readable media to perform operations including receiving well data of a plurality of wells and facility data of one or more facilities to be connected to the plurality of wells; preprocessing the well data and the facility data; clustering the plurality of wells into one or more clusters based on the well data, each cluster including wells having a similarity degree more than a predetermined threshold; classifying, using a multi-label classification, the one or more clusters based on the well data and the facility data to predict the surface components for the plurality of wells and a probability value of each predicted surface component; and connecting the plurality of wells to the one or more facilities using at least one of the predicted surface components.

### TECHNICAL FIELD

This disclosure relates generally to hydrocarbon exploration, drilling, and production, and more particularly, an adaptive well tie-in system.

### BACKGROUND

A tie-in as used in the oil and gas industry involves connecting a newly drilled well to production facilities, enabling the transfer of extracted oil or gas to processing or storage areas. The production facilities refer to locations or sites that house various equipment and infrastructure for the handling of oil and gas. These sites are equipped with devices like wellheads, separators, compressors, storage tanks, etc., to support hydrocarbon production.

Missing surface components on these sites would result in delaying the tie-in process.

### BRIEF DESCRIPTION OF THE FIGURES

FIG. 1 illustrates a flow chart of an example process for predicting surface components, according to some implementations.

FIG. 2A illustrates example features before encoding, according to some implementations.

FIG. 2B illustrates example field data after encoding, according to some implementations.

FIG. 3 illustrates a flow chart of an example tie-in process, according to some implementations.

FIG. 4 illustrates a user interface for selecting surface components among predicted surface components by the surface component recommender.

FIG. 5 illustrates an example surface component recommender, according to some implementations.

FIG. 6 illustrates a flow chart of an example process for predicting surface components, according to some implementations.

FIG. 7 illustrates hydrocarbon production operations that include both one or more field operations and one or more computational operations, which exchange information and control exploration for the production of hydrocarbons, according to some implementations.

FIG. 8 is a schematic illustration of an example controller (or control system) that enables an example system to detect water leaks/loss and recommend corrective repair actions, according to some implementations.

### DETAILED DESCRIPTION

A tie-in establishes a system including equipment, connections, and valves that enable the transfer of extracted oil or gas to processing or storage areas. This disclosure describes methods and systems for predicting one or more surface components for a tie-in process, using at least one machine learning model. The machine learning model includes a data preprocessor for preprocessing well data and facility data, a clustering model for grouping wells into a plurality of clusters (each cluster includes similar wells), and a classification model for predicting surface components used for tying in each well and probability values of each predicted surface component.

The surface components refer to parts, systems, or equipment that are located or operate on the surface, as opposed to being buried underground, submerged underwater, or installed in a wellbore. Example surface components include wellhead, surface pumps, blowout preventer (bop) stack, tanks and separators, control panels, etc.

Oil and gas wells are drilled and subsequently connected to production facilities. For example, hundreds of new wells can be drilled with plans to tie-in (e.g., connect) these wells with production facilities. A production facility refers to a plant or installation where the processing, treatment, and management of hydrocarbons occur. A production facility (well site) includes surface components as well as other elements that work together to handle the raw hydrocarbons extracted from wells and prepare them for transport, sale, or further refining. An analysis is conducted to identify one or more surface components of a system that enables the transfer of extracted oil or gas to processing or storage areas from a well.

In conventional well tie-in processes, one or more facility engineers obtain well data, a well location (e.g., a location coordinate) of each well, crude type (oil/gas/water) of each well, nearby pipelines, a production facility that each well is connected to, etc. The facility engineers select surface components based on the well data obtained. The facility engineers generate a well tie-in requirement report including selected surface components. The stakeholders estimate costs and provide mechanical and electrical specifications based on the well tie-in requirement report, followed by awarding contracts, material procurement, and construction work.

The mechanical and electrical specifications include mechanical or electrical work, such as power supply through overhead power lines, installment equipment such as water meters, etc., which need to be performed for tie-in. The electrical work includes installment of necessary electrical systems and connection to wells, such as pumps, flowlines, etc. The mechanical design work includes installation of downhole equipment such as pumps, blowouts, and production facilities.

However, any deficiencies in the well tie-in requirement report can lead to a change of scope if a surface component is missing, which results in additional costs and delays. For example, in response to the facility engineers'report missing one or more surface components, additional well data is collected for further evaluation and facility engineers generate an updated well tie-in requirement report. Accordingly, the conventional tie-in process is prone to inefficiencies and errors due to a large number of wells involved and the varying domain knowledge of different facility engineers.

An adaptive well tie-in system as described herein includes a trained machine learning model. In examples, training of a machine learning model using historical well data includes clustering wells so that similar wells are clustered in one group, and classifying the clustered wells with respect to connected facilities. For example, well clustering is performed based on geospatial data, well type, and field information. The well clustering is used to group nearby wells that exhibit the same behaviors. The well classifying utilizes previously labeled clustered data with respect to connected facilities/plants and applies multi-label classification (e.g., Random Forest Multi-Label classification). The output of the machine learning model predicts probability values of surface components used for a tie-in process.

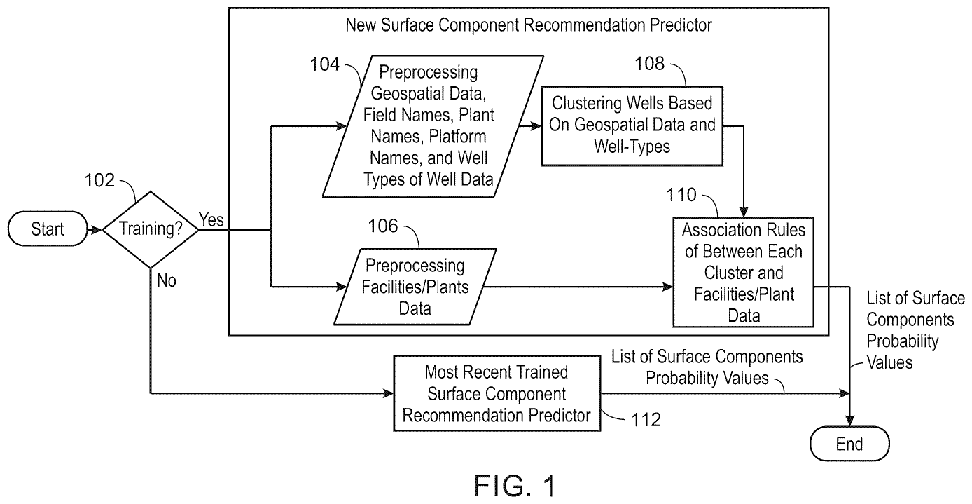

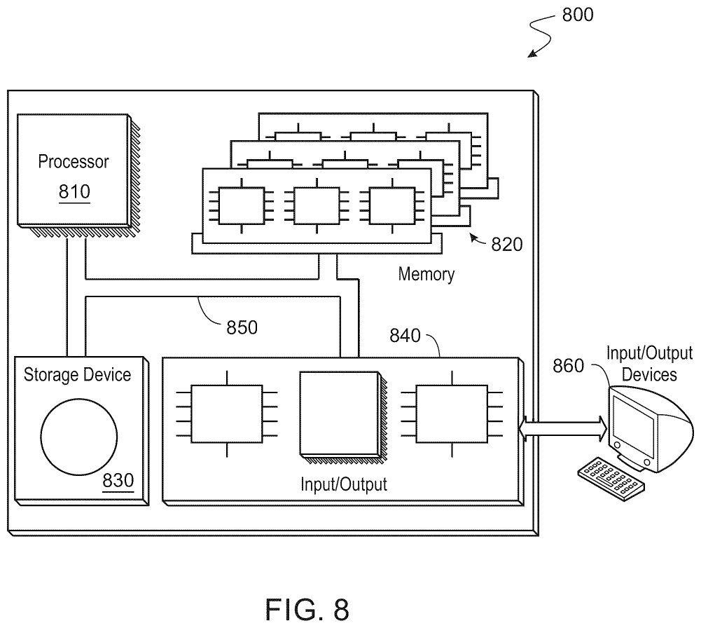

FIG. 1 illustrates a flow chart of an example process 100 for predicting surface components, according to some implementations. Process 100 is described as being performed by a computing device including one or more processors or a controller, such as controller 800 of FIG. 8. The example process 100 shown in FIG. 1 can be modified or reconfigured to include additional, fewer, or different steps (not shown in FIG. 1), which can be performed in the order shown or in a different order.

At 102, a trained machine learning model is evaluated to determine whether to retrain the trained machine learning model, e.g., a surface component recommendation predictor. In examples, a machine learning model is trained using a set of well data and facility data. Once the training phase is completed, the surface component recommendation predictor can be used to predict surface components for a plurality of wells. If the trained machine learning model is retrained, the controller proceeds to 104. If the trained machine learning model is not retrained, the controller uses the previously trained machine learning model 112 (e.g., the most recent trained surface component recommendation predictor) to output predictions. Retraining the surface component recommendation predictor with new surface components and technique enhancements is performed over a period of time depending on various factors such as the complexity of the dataset, the size of the dataset, and the computational resources available. Retraining the surface component recommendation predictor can be performed periodically, e.g., every six months.

At 104, the controller preprocesses well data including geospatial data, field name, plant name, platform name, and well type of each well. The geospatial data indicates the location of each well, e.g., the longitude and latitude coordinates of each well. The field name identifies the particular oil and gas field to which the well data belongs. The plant name identifies at least one or more plants associated with the well data. Similarly, the platform name identifies at least one or more platforms associated with the well data. The well type describes a type of each well.

At 106, the controller preprocesses facility data. The facility data includes information about the surface infrastructure used in oil and gas production, such as production facility metrics (e.g., pressure, temperature, and flow rates within pipelines, separators, compressors, and other surface equipment), operational status data (e.g., data on the functionality and performance of equipment, energy and resource consumption data (e.g., information on energy usage, chemical injections, or other operational inputs), etc.

In some implementations, the controller preprocesses the well data and the facility data. The preprocessing includes cleaning well data and facility data and encoding categorial variables to a numerical format. Cleaning data includes removing any inconsistencies, incorrect or duplicate records, and handling missing values in the well data and facility data (e.g., adding “0” to all the missing values). In some examples, some well data may be subjected to feature engineering for extracting useful information that can be used to train the machine learning model.

The cleaned data is then formatted into a specific structure and standardized by encoding categorical variables to a numerical format, making it suitable for training the machine learning model. For example, field names, well types, and facility data can be represented as numerical values. The numerical values are further grouped by each project number, each group including all the encoded facility data (surface components). There are numerous possible surface components, and they are typically encoded using techniques, such as One-Hot Encoding (OHE) or Label Encoding, to transform the possible surface components into numerical representations that the machine learning model can understand. The other categorical features, such as field names, plant names, platform names, and well types can also be encoded similarly. By incorporating both encoded surface components and other categorical features, the machine learning model gains a comprehensive understanding of the well site environment and can generate accurate predictions for desired surface components.

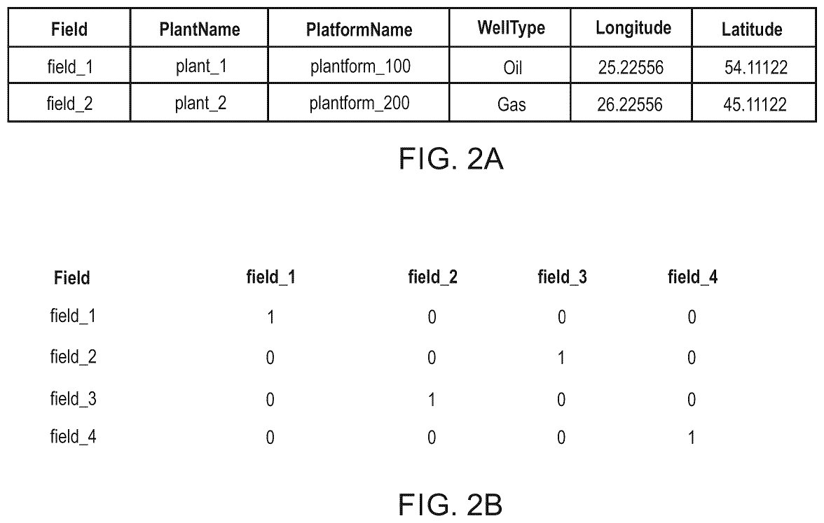

FIG. 2A illustrates example features before encoding, and FIG. 2B illustrates example field data after encoding. The “field” data of FIG. 2A is encoded to generate data as shown in FIG. 2B. “1” represents a “Yes”, and “0” represents a “No”.

The geospatial data includes information related to the location of each well (oil, gas, water). In some implementations, a Haversine distance for each pair of latitude and longitude coordinates is calculated to convert 2D geographic coordinates into a single feature representing a radial distance from a reference point (e.g., an origin point such as a wellhead). The Haversine distance is a formula used to calculate the shortest distance between two points (e.g., between a well and an origin point) on the surface of a sphere. When calculating the Haversine distance, the latitude and longitude values are calculated from degrees to radians. The radian values can be stored as, e.g., Radian_Latitude and Radian_Longitude. The preprocessing of geospatial data can allow effective utilization of the geospatial data in the machine learning model, taking advantage of the rich information inherent in the geometric data.

At 108, the wells are clustered based on the geospatial data and well types. Each cluster includes similar wells and each cluster is assigned a unique integer number. As to each cluster, numerous iterations (numerous trials to find the optimal distance between wells) are performed to determine a maximum distance between wells that exhibit the same behaviors. For example, the similar wells in a cluster exhibit similar patterns, trends, or responses to certain stimuli. The similar wells in a cluster display comparable characteristics, performances, or reactions when subjected to similar operating conditions, treatments, or external factors. In some embodiments, the clustering is K-means clustering, where wells are assigned to clusters such that the sum of the squared distances between a respective well and the cluster centroid is minimized. In some embodiments, the clustering is Density-Based Spatial Clustering of Applications with Noise (DBSCAN) based clustering, where wells that are closely packed together are grouped. Closely packed wells may be, for example, within a threshold distance from at least one well of the cluster.

At 110, surface components are associated with each cluster and surface components can be predicted for all the wells, with a probability value for each predicted surface component. Associating clusters with surface components involves identifying patterns and relationships between the clustered wells and their corresponding surface components or features. For instance, Cluster A includes a group of wells sharing similarities in properties like well type, a facility that the group of wells are connected to, and geographical proximity. Historical data and the machine learning model indicate that wells within the Cluster A have similar surface components.

The association or correlation refers to statistical relationships between various surface components measured across multiple similar wells in a cluster. The association or correlation can be used to identify patterns, connections, and dependencies between seemingly unrelated surface components, which can improve predictions of the machine learning model.

Wells are clustered based on similar characteristics at a specific location to understand a relationship between clustered wells and a distance between each well in each cluster. This allows for predicting the surface components that are likely needed to be installed for a particular well using historical data. The clustering at 108 identifies patterns in the historical data that can be used to identify the most suitable surface components for a specific location based on the characteristics of the nearby wells. In some examples, machine learning algorithms can analyze historical data to identify trends and patterns in the historical data that can help make predictions about future wells at similar locations.

Historical data indicates that multiple surface components tend to appear together frequently within a same cluster of wells, and thus it is likely to predict the multiple surface components for a given well within that cluster. The co-occurrence pattern of the multiple surface components is observed based on the number of surface component installations in neighboring wells, e.g., the number of installing a spare nozzle with Double Block and Bleed (DB&B) valve, the number of adjusting a pad level to accommodate wing valve elevation, the number of installing an annulus riser, etc.

If quite a number of nearby wells adopt multiple surface components for each well, the machine learning model is trained to adopt the multiple surface components for a newly drilled well within the same cluster, leveraging insights gained from past installation trends and patterns.

A multi-label classification technique is used to obtain multi-label classes that need to be considered in the prediction. In multi-label classification, each well is assigned multiple labels simultaneously and each label corresponds to a surface component. The multi-label classification technique is used to determine various surface equipment components for a well, and assign multiple labels concurrently to a well associated with several surface components simultaneously. For example, a well is labeled with two surface components such as “pumps” and “valves”. In some implementations, the predicted surface components are ranked based on probability values from the highest to the lowest. The predicted surface components are ranked according to probability values of prediction, from highest to lowest probability.

In some implementations, the predicted surface components and probability values are stored in a storage device for engineers'use. In some implementations, the predicted surface components and probability values are reported to a facility engineer and the occupied computational resources, e.g., server resources, can be released. In some implementations, the machine learning model can be retrained. After a machine learning model is trained, it can predict surface components for engineers'use. The machine learning model can be retrained regularly. The updates to the machine learning model are integrated into the machine learning model, ensuring transparency and consistency in the predictive output provided to engineers.

Example surface components include Cathodic Protection (CP), Surface Panel for PDHMS, Multiphase Flow Meter (MPFM), SCADA, Surface panel for Smart Well Completion, High Integrity Protection System (HIPS), ESP Surface component installation & commissioning, Deep-anode Beds Cathodic Protection, Scale Inhibition System, Water Flow Meter, Motor Operated Injection Choke Valve, Drain Pit Fence Type-V (e.g., 40*40 Meters), Drain Pit (e.g., 30*30 Meters, Fence Type-V (50*50 Meters)), Choke Valve, Data Acquisition System (DAS), Reinforced Thermoplastic Pipe (RTP), Well Site Type II, Wellsite Electrification, Electrical Transient and Analysis Program (ETAP), Wellsite Instrumentation, Remote Terminal Unit (RTU)/Supervisory Control and Data Acquisition (SCADA), Cladded Spools, Hydrogen Sulfide (H₂S) Detection System, Wellhead Operating Platform & Guard Rail, Modular Skid, etc.

Use Case

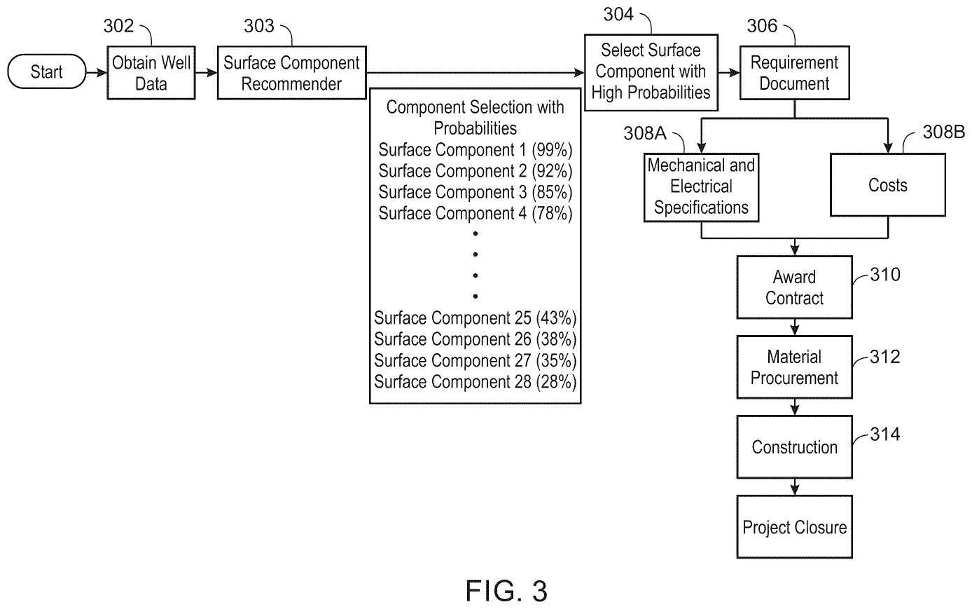

The trained machine learning model can be used to generate a well tie-in requirement report. This significantly improves efficiency of the tie-in process by more than 85%. FIG. 3 illustrates a flow chart of an example tie-in process 300, according to some implementations. Process 300 is described as being performed by a computing device including one or more processors or a controller, such as controller 800 of FIG. 8. The example process 300 shown in FIG. 3 can be modified or reconfigured to include additional, fewer, or different steps (not shown in FIG. 3), which can be performed in the order shown or in a different order.

At 302, well data is obtained, including tie-in factors such as a well location of each well, crude type (oil/gas) of each well, a production facility that each well is connected to, etc.

At 303, A trained machine learning model is executed to predict surface components and a probability value of each surface component based on the obtained well data.

At 304, a surface component with a probability value more than a predetermined threshold value, e.g., 60% is selected. For example, as shown in FIG. 3, surface component 1 has a probability of 99%, surface component 2 has a probability of 92%, surface component 3 has a probability of 85%, and surface component 4 has a probability of 78%. Surface component 1 is selected for the system since it has a highest probability of being included in a tie-in of a respective well.

At 306, the facility engineers generate a well tie-in requirement report including selected surface components. At 308A and 308B, stakeholders estimate costs and provide mechanical and electrical specifications based on the well tie-in requirement report, followed by awarding contracts 310, material procurement 312, and construction work 314.

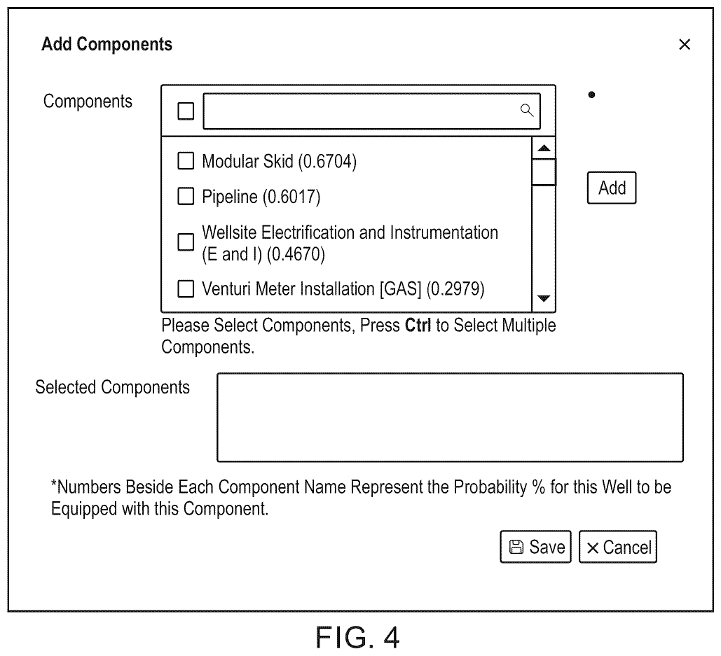

With the automatic prediction by the surface component recommender, the chance of a change of scope can be reduced, compared to manual determination of surface components by facility engineers. FIG. 4 illustrates a user interface for selecting surface components among predicted surface components by the surface component recommender. The surface component recommender can group similar wells into clusters and classify these clusters to predict the most likely surface components.

In some implementations, the wells are grouped into clusters based on well characteristics, such as geospatial location, field name, plant name, and well type. The clustering technique can use unsupervised learning, which can identify patterns and relationships in the characteristics data. In some implementations, each cluster is analyzed to determine the most likely surface components associated with this cluster. The classification technique can use a multi-label classification approach, which assigns a probability value to each surface component based on the characteristics of the wells in the cluster.

By combining the clustering and classification techniques, the surface component recommender can output a list of predicted surface components for each well, as well as their corresponding probability values. The output prediction can enable the engineers to make informed decisions about associating wells with the most suitable surface components, thereby streamlining infrastructure planning and development.

For example, the clustering model generates clusters based on well characteristics, each cluster including wells having similar geospatial locations and well types. As shown in FIG. 4, the classification model analyzes these clusters and assigns probability values to modular skid, pipeline, and other surface components. The modular skid is assigned with the highest probability value 0.6704 for a first cluster. Similarly, Pipeline receives a second highest score (0.6017) for a second cluster. The wells in the second cluster have distinct geospatial locations and well types from those of wells in the first cluster. The predictions as shown in FIG. 4 can facilitate informed decisions about surface component deployment, maximizing efficiency and reducing costs.

### Machine Learning Model

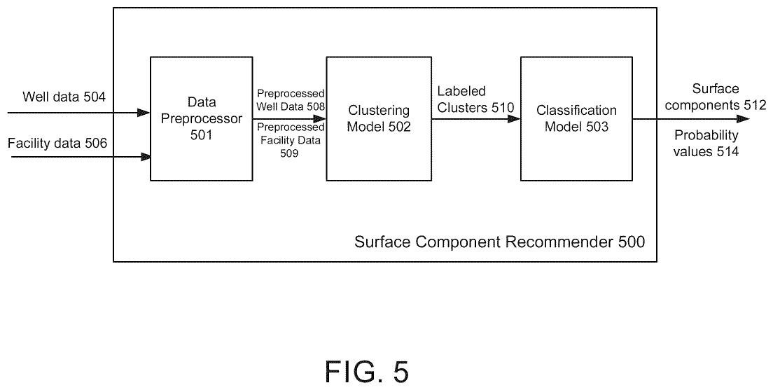

FIG. 5 illustrates an example trained machine learning model 500, according to some implementations. The trained machine learning model 500 includes a data preprocessor 501, a clustering model 502, and a classification model 503. The machine learning model is trained using historical well data and historic facility data. The trained machine learning model can be used to predict surface components for new wells.

Well data 504, such as geospatial data, a well type of each well, a field name of each well, a plant name of each well, a platform name of each well, and facility data 506 are input into the data preprocessor 501. The data preprocessor 501 cleans well data 504 and facility data 506, and encodes the cleaned data to a numerical format. Cleaning well data 504 and facility data 506 includes removing any inconsistencies, incorrect or duplicate records, and handling missing values in the well data 504 and facility data 506. The cleaned data is encoded to transform the cleaned data into numerical representations that the clustering model 502 and the classification model 503 can understand. The data preprocessor 501 outputs the preprocessed well data 508 and the preprocessed facility data 509.

The preprocessed well data 508 and the preprocessed facility data 509 are input into clustering model 502. The clustering model 502 groups similar wells based on the preprocessed well data 508 to generate clusters 510. The clustering model 502 can identify patterns and structures within the preprocessed well data 508 that explain behaviors of the wells.

Patterns and structures refer to the underlying relationships and organization within the preprocessed well data 508. Patterns involve recurring trends, correlations, and relationships between well attributes, while structures encompass the hierarchical frameworks and networks present in the preprocessed well data 508. Examples of patterns and structures include: spatial dependencies and temporal patterns, correlations between well parameters, geological formations and infrastructure networks, operational regimes and standardized procedures, etc. Identifying these patterns and structures can enable the clustering model 502 to group similar wells together, develop predictive insights, and inform cluster labeling and improve understanding.

The clustering model 502 can use these patterns in a learning stage, improving accuracy in prediction by the classification model 503. The clustering model 502 can label each cluster using the preprocessed well data 508 and the preprocessed facility data 509. Example labels include Cladding, Cathodic Protection (CP), Carbon Steel Pipeline, Desander, etc.

In some implementations, the labeled clusters 510 can be presented in one data frame/table to be used in training of the classification model 503.

The labeled clusters 510 are input into the classification model 503, which predicts surface components and a probability value of each surface component. The classification model 503 can apply a multi-label classification technique to make predictions. The multi-label classification is a type of supervised learning task where each instance can belong to multiple classes or categories simultaneously. The multi-label classification assigns multiple labels to an instance, allowing it to belong to more than one category.

The classification model 503 can assign multiple labels to each well, indicating the presence of different surface components. Examples of multiple labels assigned by the classification model include a first well labeled with {“Modular Skid”, “Pipeline”} and a second well labeled with {“Desander”, “Carbon Steel Pipeline”}.

Labels assigned by the clustering model 502 (labeled clusters 510) represent broad categorizations of wells based on similarities in their characteristics (e.g., Cladding, Cathodic Protection, etc.) are fewer in number (e.g., dozens of labeled clusters 510). The labeled clusters 510 can organize and structure well data for further analysis. Multiple labels assigned by the classification model 503 indicate the presence of specific surface components or features associated with individual wells. The labels representing surface components 512 can be numerous (e.g., hundreds of surface components 512).

The clustering model 502 provides coarse-grained labels 510 representing general categories, while the classification model 503 offers finer-grained labels 512 highlighting specific surface components or features. These complementary techniques enable comprehensive analysis and modeling of the well data.

The multi-label classification can be used to predict the probable classes of surface components to be installed. The multi-label classification is used to identify the complex relationships between different surface components and accurately forecast the probability values of co-installations.

For example, the surface component recommender 500 outputs the following predictions: Cladding: 80%, Cathodic Protection: 60%, Carbon Steel Pipeline: 40%. The predictions indicate that Cladding is highly likely to be needed (80%), while the Cathodic Protection and Carbon Steel Pipeline are also potential surface components or requirements related to surface components, albeit with lower probabilities. By analyzing these predictions, the facility engineers can make informed decisions about which surface components to install, minimizing waste and optimizing resource allocation.

### Example Process

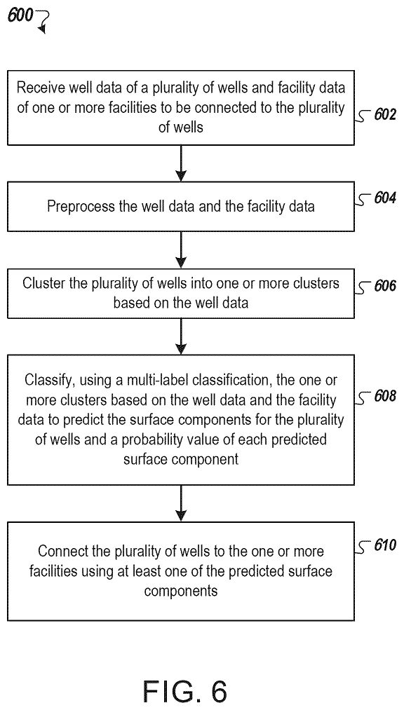

FIG. 6 illustrates a flow chart of an example process 600 for predicting surface components, according to some implementations. Process 600 is described as being performed by a computing device including one or more processors or a controller, such as controller 800 of FIG. 8. The example process 600 shown in FIG. 6 can be modified or reconfigured to include additional, fewer, or different steps (not shown in FIG. 6), which can be performed in the order shown or in a different order.

At 602, the well data of a plurality of wells and facility data of one or more facilities to be connected to the plurality of wells is obtained. In some implementations, the well data includes geospatial data, a field name, a plant name, a platform name, and a well type of each well.

At 604, the well data and the facility data are preprocessed.

In some implementations, the preprocessing further includes cleaning the well data and the facility data and encoding the cleaned well data and the cleaned facility data into a numerical format.

In some implementations, the cleaning includes removing any inconsistent, incorrect, or duplicate records from the well data and the facility data and handling missing values in the well data and facility data.

The cleaned well data includes geospatial data including a pair of latitude coordinate and longitude coordinate for each well. Encoding the cleaned well data further includes calculating a Haversine distance for the pair of latitude coordinate and longitude coordinate to convert the pair of latitude coordinate and longitude coordinate into a single feature representing a radial distance from a reference point. The encoding can be One-Hot Encoding (OHE) or Label Encoding.

At 606, the plurality of wells are clustered into one or more clusters based on the well data. Each cluster includes wells having a similarity degree more than a predetermined threshold. The similar wells in a cluster exhibit similar patterns, trends, or responses to certain stimuli. The similar wells in a cluster display comparable characteristics, performances, or reactions when subjected to similar operating conditions, treatments, or external factors.

At 608, the one or more clusters are classified using a multi-label classification based on the well data and the facility data to predict surface components for the plurality of wells and a probability value of each predicted surface component. In some implementations, the predicted surface components can be ranked based on the probability value of each predicted surface component.

At 610, the plurality of wells are connected to the one or more facilities using at least one of the predicted surface components.

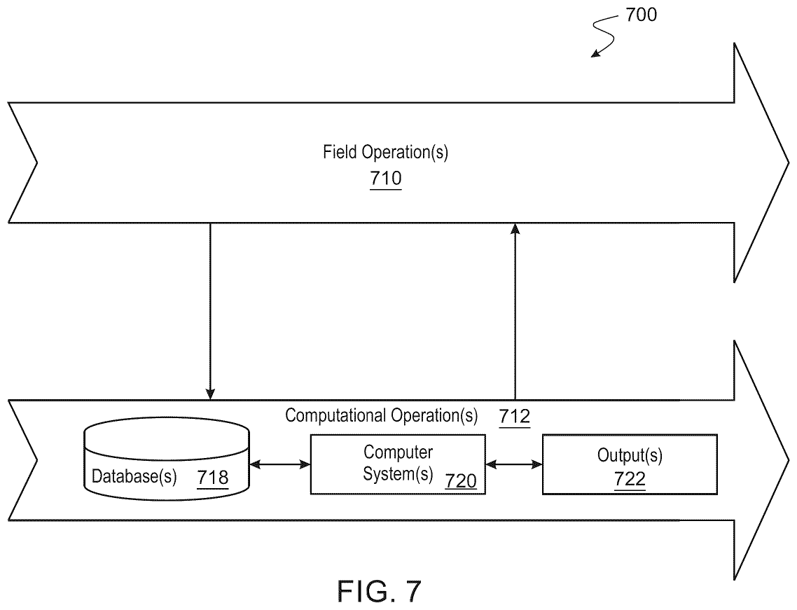

FIG. 7 illustrates hydrocarbon production operations 700 that include both one or more field operations 710 and one or more computational operations 712, which exchange information and control exploration for the production of hydrocarbons. In some implementations, outputs of techniques of the present disclosure can be performed before, during, or in combination with the hydrocarbon production operations 700, specifically, for example, either as field operations 710 or computational operations 712, or both.

Examples of field operations 710 include forming/drilling a wellbore, hydraulic fracturing, producing through the wellbore, and injecting fluids (such as water) through the wellbore, to name a few. In some implementations, methods of the present disclosure can trigger or control the field operations 710. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 710 and responsively triggering the field operations 710 including, for example, generating plans and signals that provide feedback to and control physical components of the field operations 710. Alternatively or in addition, the field operations 710 can trigger the methods of the present disclosure. For example, implementing physical components (including, for example, hardware, such as sensors) deployed in the field operations 710 can generate plans and signals that can be provided as input or feedback (or both) to the methods of the present disclosure.

Examples of computational operations 712 include one or more computer systems 720 that include one or more processors and computer-readable media (e.g., non-transitory computer-readable media) operatively coupled to the one or more processors to execute computer operations to perform the methods of the present disclosure. The computational operations 712 can be implemented using one or more databases 718, which store data received from the field operations 710 and/or generated internally within the computational operations 712 (e.g., by implementing the methods of the present disclosure) or both. For example, the one or more computer systems 720 process inputs from the field operations 710 to assess conditions in the physical world, the outputs of which are stored in the databases 718. For example, seismic sensors of the field operations 710 can be used to perform a seismic survey to map subterranean features, such as facies and faults. In performing a seismic survey, seismic sources (e.g., seismic vibrators or explosions) generate seismic waves that propagate in the Earth, and seismic receivers (e.g., geophones) measure reflections generated as the seismic waves interact with boundaries between layers of a subsurface formation. The source and received signals are provided to the computational operations 712 where they are stored in the databases 718 and analyzed by the one or more computer systems 720.

In some implementations, one or more outputs 722 generated by the one or more computer systems 720 can be provided as feedback/input to the field operations 710 (either as direct input or stored in the databases 718). The field operations 710 can use the feedback/input to control physical components used to perform the field operations 710 in the real world.

For example, the computational operations 712 can process the seismic data to generate three-dimensional (3D) maps of the subsurface formation. The computational operations 712 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 712 to process new information about the formation and control the drilling to adjust to the observed conditions in real time.

The one or more computer systems 720 can update the 3D maps of the subsurface formation as information from one exploration well is received, and the computational operations 712 can adjust the location of the next exploration well based on the updated 3D maps. Similarly, the data received from production operations can be used by the computational operations 712 to control components of the production operations. For example, production well and pipeline data can be analyzed to predict slugging in pipelines leading to a refinery, and the computational operations 712 can control machine operated valves upstream of the refinery to reduce the likelihood of plant disruptions that run the risk of taking the plant offline.

In some implementations of the computational operations 712, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

FIG. 8 is a schematic illustration of an example controller 800 (or control system) that enables an example system to detect water leaks/loss and recommend corrective repair actions, according to some implementations. For example, the controller 800 may be operable according to the processes 100 and 600 of FIGS. 1 and 6. The controller 800 is intended to include various forms of digital computers, such as printed circuit boards (PCB), processors, digital circuitry, or otherwise parts of a system for supply chain alert management. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 800 includes a processor 810, a memory 820, a storage device 830, and an input/output interface 840 communicatively coupled with input/output devices 860 (for example, displays, keyboards, measurement devices, sensors, valves, pumps). Each of the components 810, 820, 830, and 840 are interconnected using a system bus 850. The processor 810 is capable of processing instructions for execution within the controller 800. The processor may be designed using any of a number of architectures. For example, the processor 810 may be a CISC (Complex Instruction Set Computers) processor, a RISC (Reduced Instruction Set Computer) processor, or a MISC (Minimal Instruction Set Computer) processor.

In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output interface 840.

The memory 820 stores information within the controller 800. In one implementation, the memory 820 is a computer-readable medium. In one implementation, the memory 820 is a volatile memory unit. In another implementation, the memory 820 is a non-volatile memory unit.

The storage device 830 is capable of providing mass storage for the controller 800. In one implementation, the storage device 830 is a computer-readable medium. In various different implementations, the storage device 830 may be a floppy disk device, a hard disk device, an optical disk device, or a tape device.

The input/output interface 840 provides input/output operations for the controller 800. In one implementation, the input/output devices 860 include a keyboard and/or pointing device. In another implementation, the input/output devices 860 includes a display unit for displaying graphical user interfaces.

There can be any number of controllers 800 associated with, or external to, a computer system containing controller 800, with each controller 800 communicating over a network. Further, the terms “client,” “user,” and other appropriate terminology can be used interchangeably, as appropriate, without departing from the scope of the present disclosure. Moreover, the present disclosure contemplates that many users can use one controller 800, and one user can use multiple controllers 800.

### Embodiments/Examples

According to some non-limiting embodiments or examples, provided is a computer-implemented method for predicting surface components, comprising: receiving well data of a plurality of wells and facility data of one or more facilities to be connected to the plurality of wells; preprocessing the well data and the facility data; clustering the plurality of wells into one or more clusters based on the well data, each cluster including wells having a similarity degree more than a predetermined threshold; classifying, using a multi-label classification, the one or more clusters based on the well data and the facility data to predict the surface components for the plurality of wells and a probability value of each predicted surface component; and connecting the plurality of wells to the one or more facilities using at least one of the predicted surface components.

According to some non-limiting embodiments or examples, provided is an apparatus comprising a non-transitory, computer readable, storage medium that stores instructions that, when executed by at least one processor, cause the at least one processor to perform operations comprising: receiving well data of a plurality of wells and facility data of one or more facilities to be connected to the plurality of wells; preprocessing the well data and the facility data; clustering the plurality of wells into one or more clusters based on the well data, each cluster including wells having a similarity degree more than a predetermined threshold; classifying, using a multi-label classification, the one or more clusters based on the well data and the facility data to predict surface components for the plurality of wells and a probability value of each predicted surface component; and connecting the plurality of wells to the one or more facilities using at least one of the predicted surface components.

According to some non-limiting embodiments or examples, provided is a system, comprising: one or more memory modules; and one or more hardware processors communicably coupled to the one or more memory modules, the one or more hardware processors configured to execute instructions stored on the one or more memory modules to perform operations comprising: receiving well data of a plurality of wells and facility data of one or more facilities to be connected to the plurality of wells; preprocessing the well data and the facility data; clustering the plurality of wells into one or more clusters based on the well data, each cluster including wells having a similarity degree more than a predetermined threshold; classifying, using a multi-label classification, the one or more clusters based on the well data and the facility data to predict surface components for the plurality of wells and a probability value of each predicted surface component; and connecting the plurality of wells to the one or more facilities using at least one of the predicted surface components.

Further non-limiting aspects or embodiments are set forth in the following numbered embodiments:

Embodiment 1: A computer-implemented method for predicting surface components, comprising: receiving well data of a plurality of wells and facility data of one or more facilities to be connected to the plurality of wells; preprocessing the well data and the facility data; clustering the plurality of wells into one or more clusters based on the well data, each cluster including wells having a similarity degree more than a predetermined threshold; classifying, using a multi-label classification, the one or more clusters based on the well data and the facility data to predict the surface components for the plurality of wells and a probability value of each predicted surface component; and connecting the plurality of wells to the one or more facilities using at least one of the predicted surface components.

Embodiment 2: The computer-implemented method of Embodiment 1, wherein the well data comprises geospatial data, a field name, a plant name, a platform name, and a well type of each well.

Embodiment 3: The computer-implemented method of Embodiment 1 or 2, wherein the preprocessing further comprises: cleaning the well data and the facility data; and encoding the cleaned well data and the cleaned facility data into a numerical format.

Embodiment 4: The computer-implemented method of Embodiment 3, wherein the cleaning comprises: removing any inconsistent, incorrect, or duplicate records from the well data and the facility data, and handling missing values in the well data and the facility data.

Embodiment 5: The computer-implemented method of Embodiment 3, wherein the cleaned well data comprises geospatial data including a pair of latitude coordinate and longitude coordinate for each well, wherein encoding the cleaned well data further comprises: calculating a Haversine distance for the pair of a latitude coordinate and a longitude coordinate to convert the pair of the latitude coordinate and the longitude coordinate into a single feature representing a radial distance from a reference point.

Embodiment 6: The computer-implemented method of Embodiment 3, wherein the encoding comprises One-Hot Encoding (OHE) or Label Encoding.

Embodiment 7: The computer-implemented method of any one of previous Embodiments, further comprising: ranking the predicted surface components based on the probability value of each predicted surface component.

Embodiment 8: An apparatus comprising a non-transitory, computer readable, storage medium that stores instructions that, when executed by at least one processor, cause the at least one processor to perform operations comprising: receiving well data of a plurality of wells and facility data of one or more facilities to be connected to the plurality of wells; preprocessing the well data and the facility data; clustering the plurality of wells into one or more clusters based on the well data, each cluster including wells having a similarity degree more than a predetermined threshold; classifying, using a multi-label classification, the one or more clusters based on the well data and the facility data to predict surface components for the plurality of wells and a probability value of each predicted surface component; and connecting the plurality of wells to the one or more facilities using at least one of the predicted surface components.

Embodiment 9: The apparatus of Embodiment 8, wherein the well data comprises geospatial data, a field name, a plant name, a platform name, and a well type of each well.

Embodiment 10: The apparatus of Embodiment 8 or 9, wherein the preprocessing further comprises: cleaning the well data and the facility data; and encoding the cleaned well data and the cleaned facility data into a numerical format.

Embodiment 11: The apparatus of Embodiment 10, wherein the cleaning comprises: removing any inconsistent, incorrect, or duplicate records from the well data and the facility data, and handling missing values in the well data and the facility data.

Embodiment 12: The apparatus of Embodiment 10, wherein the cleaned well data comprises geospatial data including a pair of latitude coordinate and longitude coordinate for each well, wherein encoding the cleaned well data further comprises: calculating a Haversine distance for the pair of a latitude coordinate and a longitude coordinate to convert the pair of the latitude coordinate and the longitude coordinate into a single feature representing a radial distance from a reference point.

Embodiment 13: The apparatus of Embodiment 10, wherein the encoding comprises One-Hot Encoding (OHE) or Label Encoding.

Embodiment 14: The apparatus of any one of previous Embodiments, further comprising: ranking the predicted surface components based on the probability value of each predicted surface component.

Embodiment 15: A system, comprising: one or more memory modules; and one or more hardware processors communicably coupled to the one or more memory modules, the one or more hardware processors configured to execute instructions stored on the one or more memory modules to perform operations comprising: receiving well data of a plurality of wells and facility data of one or more facilities to be connected to the plurality of wells; preprocessing the well data and the facility data; clustering the plurality of wells into one or more clusters based on the well data, each cluster including wells having a similarity degree more than a predetermined threshold; classifying, using a multi-label classification, the one or more clusters based on the well data and the facility data to predict surface components for the plurality of wells and a probability value of each predicted surface component; and connecting the plurality of wells to the one or more facilities using at least one of the predicted surface components.

Embodiment 16: The system of Embodiment 15, wherein the well data comprises geospatial data, a field name, a plant name, a platform name, and a well type of each well.

Embodiment 17: The system of Embodiment 15 or 16, wherein the preprocessing further comprises: cleaning the well data and the facility data; and encoding the cleaned well data and the cleaned facility data into a numerical format.

Embodiment 18: The system of Embodiment 17, wherein the cleaning comprises: removing any inconsistent, incorrect, or duplicate records from the well data and the facility data, and handling missing values in the well data and the facility data.

Embodiment 19: The system of Embodiment 17, wherein the cleaned well data comprises geospatial data including a pair of latitude coordinate and longitude coordinate for each well, wherein encoding the cleaned well data further comprises: calculating a Haversine distance for the pair of a latitude coordinate and a longitude coordinate to convert the pair of the latitude coordinate and the longitude coordinate into a single feature representing a radial distance from a reference point.

Embodiment 20: The system of Embodiment 17, wherein the encoding comprises One-Hot Encoding (OHE) or Label Encoding.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware-or software-based (or a combination of both hardware-and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video Disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Various components may be described as performing a task or tasks, for convenience in the description. Such descriptions should be interpreted as including the phrase “configured to.” Reciting a component that is configured to perform one or more tasks is expressly intended not to invoke 35 USC § 112(f) interpretation for that component.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

We claim:

1. A computer-implemented method for predicting surface components, comprising:
receiving well data of a plurality of wells and facility data of one or more facilities to be connected to the plurality of wells;
preprocessing the well data and the facility data;
clustering the plurality of wells into one or more clusters based on the well data, each cluster including wells having a similarity degree more than a predetermined threshold;
classifying, using a multi-label classification, the one or more clusters based on the well data and the facility data to predict the surface components for the plurality of wells and a probability value of each predicted surface component; and
connecting the plurality of wells to the one or more facilities using at least one of the predicted surface components.

2. The computer-implemented method of claim 1, wherein the well data comprises geospatial data, a field name, a plant name, a platform name, and a well type of each well.

3. The computer-implemented method of claim 1, wherein the preprocessing further comprises:
cleaning the well data and the facility data; and
encoding the cleaned well data and the cleaned facility data into a numerical format.

4. The computer-implemented method of claim 3, wherein the cleaning comprises:
removing any inconsistent, incorrect, or duplicate records from the well data and the facility data, and
handling missing values in the well data and the facility data.

5. The computer-implemented method of claim 3, wherein the cleaned well data comprises geospatial data including a pair of latitude coordinate and longitude coordinate for each well, wherein encoding the cleaned well data further comprises:
calculating a Haversine distance for the pair of a latitude coordinate and a longitude coordinate to convert the pair of the latitude coordinate and the longitude coordinate into a single feature representing a radial distance from a reference point.

6. The computer-implemented method of claim 3, wherein the encoding comprises One-Hot Encoding (OHE) or Label Encoding.

7. The computer-implemented method of claim 1, further comprising:
ranking the predicted surface components based on the probability value of each predicted surface component.

8. An apparatus comprising a non-transitory, computer readable, storage medium that stores instructions that, when executed by at least one processor, cause the at least one processor to perform operations comprising:
receiving well data of a plurality of wells and facility data of one or more facilities to be connected to the plurality of wells;
preprocessing the well data and the facility data;
clustering the plurality of wells into one or more clusters based on the well data, each cluster including wells having a similarity degree more than a predetermined threshold;
classifying, using a multi-label classification, the one or more clusters based on the well data and the facility data to predict surface components for the plurality of wells and a probability value of each predicted surface component; and
connecting the plurality of wells to the one or more facilities using at least one of the predicted surface components.

9. The apparatus of claim 8, wherein the well data comprises geospatial data, a field name, a plant name, a platform name, and a well type of each well.

10. The apparatus of claim 8, wherein the preprocessing further comprises:
cleaning the well data and the facility data; and
encoding the cleaned well data and the cleaned facility data into a numerical format.

11. The apparatus of claim 10, wherein the cleaning comprises:
removing any inconsistent, incorrect, or duplicate records from the well data and the facility data, and
handling missing values in the well data and the facility data.

12. The apparatus of claim 10, wherein the cleaned well data comprises geospatial data including a pair of latitude coordinate and longitude coordinate for each well, wherein encoding the cleaned well data further comprises:
calculating a Haversine distance for the pair of a latitude coordinate and a longitude coordinate to convert the pair of the latitude coordinate and the longitude coordinate into a single feature representing a radial distance from a reference point.

13. The apparatus of claim 10, wherein the encoding comprises One-Hot Encoding (OHE) or Label Encoding.

14. The apparatus of claim 8, further comprising:
ranking the predicted surface components based on the probability value of each predicted surface component.

15. A system, comprising:
one or more memory modules; and
one or more hardware processors communicably coupled to the one or more memory modules, the one or more hardware processors configured to execute instructions stored on the one or more memory modules to perform operations comprising:
receiving well data of a plurality of wells and facility data of one or more facilities to be connected to the plurality of wells;
preprocessing the well data and the facility data;
clustering the plurality of wells into one or more clusters based on the well data, each cluster including wells having a similarity degree more than a predetermined threshold;
classifying, using a multi-label classification, the one or more clusters based on the well data and the facility data to predict surface components for the plurality of wells and a probability value of each predicted surface component; and
connecting the plurality of wells to the one or more facilities using at least one of the predicted surface components.

16. The system of claim 15, wherein the well data comprises geospatial data, a field name, a plant name, a platform name, and a well type of each well.

17. The system of claim 15, wherein the preprocessing further comprises:
cleaning the well data and the facility data; and
encoding the cleaned well data and the cleaned facility data into a numerical format.

18. The system of claim 17, wherein the cleaning comprises:
removing any inconsistent, incorrect, or duplicate records from the well data and the facility data, and
handling missing values in the well data and the facility data.

19. The system of claim 17, wherein the cleaned well data comprises geospatial data including a pair of latitude coordinate and longitude coordinate for each well, wherein encoding the cleaned well data further comprises:
calculating a Haversine distance for the pair of a latitude coordinate and a longitude coordinate to convert the pair of the latitude coordinate and the longitude coordinate into a single feature representing a radial distance from a reference point.

20. The system of claim 17, wherein the encoding comprises One-Hot Encoding (OHE) or Label Encoding.
